(19) United States
(12) Patent Application Publication
(10) Pub. No.: US 2024/0118101 A1
(43) Pub. Date: Apr. 11, 2024

(54) CONTROL APPARATUS

(71) Applicants: TOYOTA JIDOSHA KABUSHIKI KAISHA, Aichi-ken (JP); MONET Technologies Inc., Tokyo (JP)

(72) Inventors: Kenta NOSE, Kobe-shi (JP); Masaaki HASHIMOTO, Tokyo-to (JP)

(21) Appl. No.: 18/479,830

(22) Filed: Oct. 3, 2023

(30) Foreign Application Priority Data
Oct. 5, 2022 (JP) 2022-161225

(51) Int. Cl. G01C 21/34; G01C 21/36

(52) U.S. Cl. CPC G01C 21/3484; G01C 21/3438; G01C 21/3617; G01C 21/362; G01C 21/3691

(57) ABSTRACT

A control apparatus includes a controller. The controller is configured to, upon acquiring travel request information indicating a travel request of a user from a terminal apparatus of the user, select at least one candidate service from among a plurality of mobility services based on at least one piece of information from among physical condition information on the user, schedule information on the user, weather information for a scheduled travel date and time, and day of week information for the scheduled travel date, acquire a result of a route search using the at least one candidate service, and transmit the result to the terminal apparatus.

### CROSS-REFERENCE TO RELATED APPLICATION

This application claims priority to Japanese Patent Application No. 2022-161225, filed on Oct. 5, 2022, the entire contents of which are incorporated herein by reference.

### TECHNICAL FIELD

The present disclosure relates to a control apparatus.

### BACKGROUND

Technology for searching for routes using a routing engine is known. For example, Patent Literature (PTL) 1 discloses a server that performs route searches using a route search engine.

### CITATION LIST

### Patent Literature

PTL 1: JP 2010-264937 A

### SUMMARY

A dedicated Application Program Interface (API) is typically provided for each routing engine, and a single API is not used for multiple engines. When trying to use a dedicated API for various mobility services that have different specifications, the processing can become complicated due to differences in input items. Technology to search for routes in mobility services thus has room for improvement.

It would be helpful to improve technology to search for routes in mobility services.

A control apparatus according to an embodiment of the present disclosure includes a controller, wherein the controller is configured to, upon acquiring travel request information indicating a travel request of a user from a terminal apparatus of the user, select at least one candidate service from among a plurality of mobility services based on at least one piece of information from among physical condition information on the user, schedule information on the user, weather information for a scheduled travel date and time, and day of week information for the scheduled travel date, acquire a result of a route search using the at least one candidate service, and transmit the result to the terminal apparatus.

An embodiment of the present disclosure can improve the technology to search for routes in mobility services.

### BRIEF DESCRIPTION OF THE DRAWINGS

In the accompanying drawings:

FIG. 1 is a block diagram illustrating a schematic configuration of a system according to a first embodiment;

FIG. 2 is a flowchart illustrating operations of a control apparatus according to the first embodiment;

FIG. 3 is a diagram illustrating an example of request specifications according to the first embodiment;

FIG. 4 is a diagram illustrating an example of specification information according to the first embodiment;

FIG. 5 is a diagram illustrating an example of correspondence information according to a second embodiment.

### DETAILED DESCRIPTION

### First Embodiment

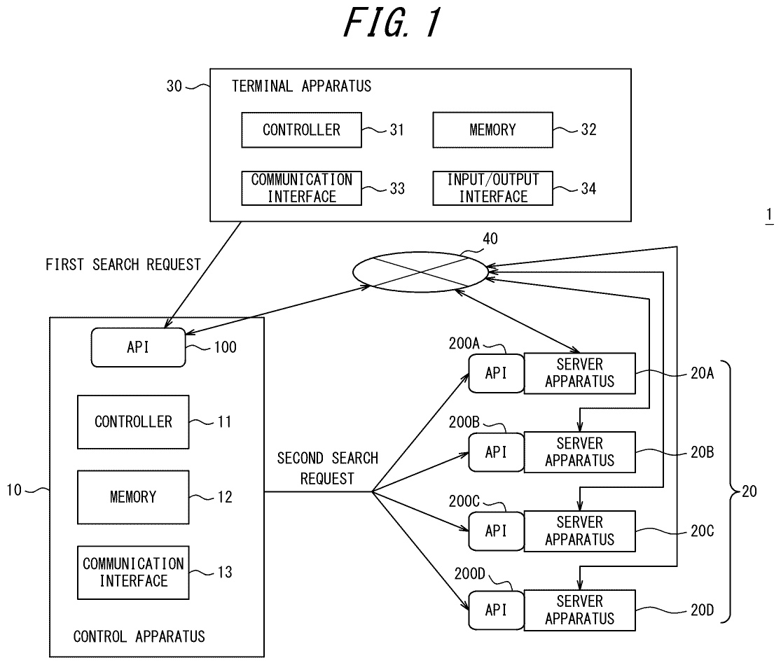

Hereinafter, a first embodiment of the present disclosure will be described. An outline of a system 1 according to an embodiment of the present disclosure will first be described with reference to FIG. 1. The system 1 includes a control apparatus 10, server apparatuses 20A to 20D, and a terminal apparatus 30. The apparatuses are communicably connected to each other via a network 40 including the Internet, for example. Four server apparatuses are illustrated in FIG. 1, but the number of server apparatuses included in the system 1 is not limited to this example. Hereafter, when no particular distinction is made, the server apparatus 20A through the server apparatus 20D are simply referred to as the “server apparatus 20”.

The control apparatus 10 is installed in a facility such as a data center. The control apparatus 10 is, for example, a server that belongs to a cloud computing system or another type of computing system. The control apparatus provides an API 100 for acquiring the results of a route search using a mobility service. As explained below, the control apparatus 10 makes a request for a route search to a server apparatus 20 pertaining to a candidate service selected from among a plurality of mobility services and provides the result of the route search via the API 100.

The server apparatus 20 is installed at a facility or the like of the provider of each mobility service. The server apparatus 20 is, for example, a server that belongs to a cloud computing system or another type of computing system. Each of the server apparatuses 20A through 20D in FIG. 1 includes a controller, a communication interface, and a memory. The memory stores a routing engine. The routing engine is an application program for searching for a route, from a point of departure to a destination, using the mobility service provided by each provider. For example, the server apparatus 20A is managed by a taxi operator, and the routing engine included in the server apparatus 20A is a program capable of performing a route search in the case of travel by taxi.

The server apparatuses 20A to 20D provide respective APIs 200A to 200D for acquiring the result of the route search using the routing engine. Hereafter, when no particular distinction is made, the API 200A through the API 200D are simply referred to as the “API 200”.

The terminal apparatus 30 is held and used by each user among a plurality of users. The terminal apparatus 30 is, for example, a mobile device such as a mobile phone, a smartphone, or a tablet.

The network 40 includes the Internet, at least one WAN, at least one MAN, or a combination thereof. The term “WAN” is an abbreviation of wide area network. The term “MAN” is an abbreviation of metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

First, an outline of the present embodiment will be described, and details thereof will be described later. Upon acquiring travel request information indicating a travel request of a user from the terminal apparatus of the user, the control apparatus 10 selects at least one candidate service from among a plurality of mobility services based on at least one piece of information from among physical condition information on the user, schedule information on the user, weather information for a scheduled travel date and time, and day of week information for the scheduled travel date, acquires the result of a route search using the at least one candidate service, and transmits the result to the terminal apparatus 30.

The travel request information includes the scheduled travel date and time, the point of departure, and the destination. This configuration is not limiting, and the travel request information may include any information about travel by the user. In FIG. 1, a first search request represents a request for performance of a route search from the terminal apparatus 30 to the control apparatus 10, and the second search request represents a request for performance of a route search from the control apparatus 10 to the server apparatus 20. The first search request including travel request information is transmitted from the terminal apparatus 30 to the control apparatus 10 via the API 100 of the control apparatus 10. Upon receiving the travel request information, the control apparatus 10 determines a required specification for a mobility service based on various information and selects a suitable mobility service as a candidate service from among the mobility services pertaining to a plurality of server apparatuses 20, as described below. The mobility services include transportation means such as buses, trains, taxis, and shared cars.

Via the API 200 provided by the server apparatus 20 pertaining to the at least one selected candidate service, the control apparatus 10 transmits a second search request based on the travel request information for the user. At this time, the control apparatus 10 can transmit the second search request according to the input format of the API 200. Upon receiving the second search request, the server apparatus 20 performs a route search using a routing engine and transmits the result back to the control apparatus 10 via the API 200. The control apparatus 10 transmits the received result back to the terminal apparatus 30 via the API 100.

According to the present embodiment, the user only needs to submit a request for a route search to the control apparatus 10 to acquire the result of the route search by the mobility service automatically selected by the control apparatus 10. Since the appropriate service for the user is automatically selected from among a plurality of mobility services, technology to search for routes in mobility services can be improved.

Next, a configuration of the control apparatus 10 included in the system 1 will be described in detail. As illustrated in FIG. 1, the control apparatus 10 includes a controller 11, a memory 12, and a communication interface 13.

The controller 11 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 11 executes processes related to operations of the control apparatus while controlling components of the control apparatus 10.

The memory 12 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 12 functions as, for example, a main memory, an auxiliary memory, or a cache memory. The memory 12 stores information to be used for the operations of the control apparatus 10 and information obtained by the operations of the control apparatus 10. For example, the memory 12 may store a system program, an application program, a database, map information, and the like. The information stored in the memory 12 may be updated with, for example, information acquired from the network 40 via the communication interface 13.

The communication interface 13 includes at least one interface for communication. The interface for communication is, for example, a LAN interface. The communication interface 13 receives information to be used for the operations of the control apparatus 10 and transmits information obtained by the operations of the control apparatus 10.

The functions of the control apparatus 10 are realized by execution of a control program according to the present embodiment by a processor corresponding to the controller 11. That is, the functions of the control apparatus 10 are realized by software. The control program causes a computer to execute the operations of the control apparatus 10, thereby causing the computer to function as the control apparatus 10. That is, the computer executes the operations of the control apparatus 10 in accordance with the control program to thereby function as the control apparatus 10.

The program can be stored on a non-transitory computer readable medium. Examples of the non-transitory computer readable medium include a magnetic recording device, an optical disk, a magneto-optical storage device, and ROM. The program is distributed by sale, transfer of ownership, or rental of a portable medium, such as a DVD or a CD-ROM, in which the program is stored. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 10 may be realized by a programmable circuit or a dedicated circuit serving as the controller 11. That is, some or all of the functions of the control apparatus 10 may be realized by hardware.

Next, a configuration of the terminal apparatus 30 included in the system 1 will be described in detail. The terminal apparatus 30 includes a controller 31, a memory 32, a communication interface 33, and an input/output interface 34.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the terminal apparatus 30 while controlling components of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the terminal apparatus 30 and information obtained by the operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth® (Bluetooth is a registered trademark in Japan, other countries, or both), or a LAN interface. The term “LTE” is an abbreviation of Long Term Evolution. The term “4G” is an abbreviation of 4th generation. The term “5G” is an abbreviation of 5th generation. The communication interface 33 receives information to be used for the operations of the terminal apparatus 30, and transmits information obtained by the operations of the terminal apparatus 30.

The input/output interface 34 includes an input interface that detects input by the user and transmits the inputted information to the controller 31. Examples of input interfaces may include, but are not limited to, a physical key, a capacitive key, a touch screen integrally provided in the panel display, and a microphone configured to receive audio input. The input/output interface 34 includes an interface for output that outputs, to a user, information generated by the controller 31 or information read from the memory 32. The interface for output may, for example, be a panel display that outputs information in the form of images, a speaker that outputs information in the form of sound, or the like, but is not limited to these, and may be any output interface. The input/output interface 34 can notify the user by audio, screen display, or the like of information acquired via the communication interface 33. The input/output interface 34 may be connected to the terminal apparatus 30 as an external output device, instead of being included in the terminal apparatus 30.

The functions of the terminal apparatus 30 are realized by execution of a terminal program according to the present embodiment by a processor included in the controller 31. That is, the functions of the terminal apparatus are realized by software. The terminal program is a program for causing a computer to execute the processing of steps included in operations of the terminal apparatus 30, thereby enabling the computer to realize the functions corresponding to the processing of the steps. That is, the terminal program is a program for causing the computer to function as the terminal apparatus 30.

Some or all of the functions of the terminal apparatus 30 may be realized by a dedicated circuit included in the controller 31. That is, some or all of the functions of the terminal apparatus 30 may be realized by hardware.

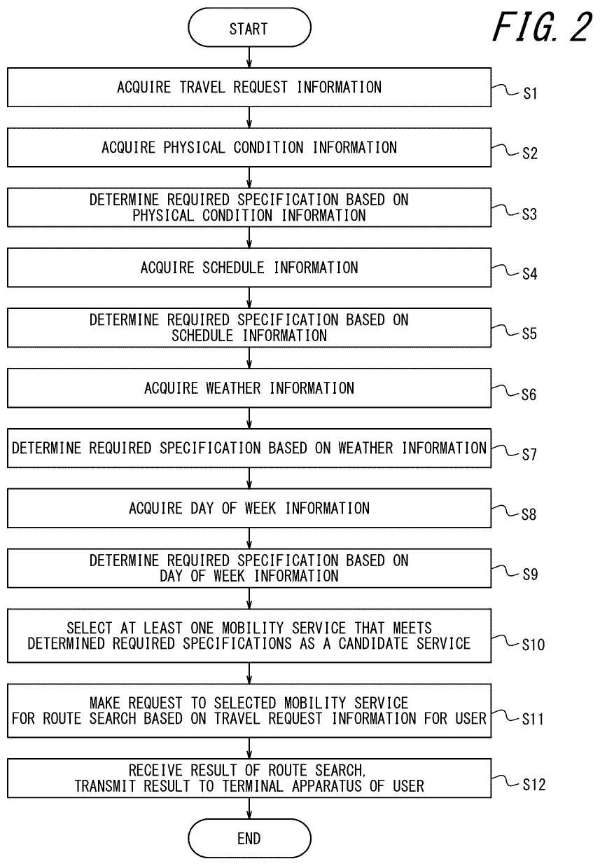

Operations of the control apparatus 10 according to the present embodiment will be described with reference to FIGS. 2 to 4. These operations correspond to a control method according to the present embodiment. The control apparatus 10 is described below as transmitting and receiving information to and from each external apparatus via the communication interface 13 and the network 40.

In step S1 of FIG. 2, the controller 11 of the control apparatus 10 acquires travel request information for the user. Any appropriate method may be used to acquire the travel request information. In the present embodiment, a first search request including travel request information is transmitted from the terminal apparatus 30 to the control apparatus 10. The controller 11 acquires the information included in the travel request information by receiving the information as input values to the API 100.

In step S2, the controller 11 acquires physical condition information indicating the physical condition of the user. Any appropriate method may be used to acquire the physical condition information. In the present embodiment, the controller 11 acquires the physical condition information by receiving the physical condition information from the terminal apparatus 30.

In the present embodiment, the physical condition information indicates the degree of the user's physical condition as a stepwise numerical value from 0 to 10. A numerical value closer to 10 indicates a better physical condition. The controller 11 may calculate the degree of the physical condition by comparison with the average for a plurality of users or by a comparison with the user's past history. The physical condition information may include any information, such as the presence of illness or injury, body temperature, or the like.

In steps S3, 5, 7, and 9 below, the controller 11 determines the value of each corresponding required specification based on each piece of acquired information. A required specification is a specification of the routing engine or the mobility service so that the controller 11 can finalize the routing engine to be used for the route search, as described below. The specifications of the routing engine or the mobility service include “response speed”, “time tolerance”, “position tolerance”, and “availability of ride sharing”. The specifications are not limited to these examples and may include any specification, such as whether accompanying pets are allowed. As explained below, these specifications are set in advance for each routing engine.

The “response speed” refers to the speed at which the routing engine can acquire the result of the route search on the server apparatus 20. In the present embodiment, the degree of the response speed is indicated by a stepwise numerical value from R1 to R10. The response speed typically slows as the conditions of the route search become more complex. For example, in a case in which the mobility service is for a shared car that allows ride sharing, a plurality of users wish to share a ride, and each user has a different point of departure and destination, the route search for the shared car becomes more complicated than the route search for a mobility service such as a bus route, and the response time becomes slower.

The “time tolerance” is the minimum time span required when a route search for each mobility service is performed. In the present embodiment, the degree of time tolerance is indicated by a stepwise numerical value from T1 to T10. The time tolerance is larger for mobility services that are more likely to fail to meet user preferences for the departure time or arrival time. For example, the time tolerance for taxis, which are dispatched after the user specifies a departure time, is a low value of T2, whereas the time tolerance for local buses is a high value of T9. As explained below, the controller 11 may select, as a candidate service, a mobility service whose time tolerance specification is lower than the user's required specification. For example, if the user's required specification is T5, the specification for a local bus as a mobility service is T9, and the specification for a taxi is T2, the controller 11 may select the taxi, which has a specification lower than the user's required specification, as a candidate service.

The “position tolerance” is the minimum position width required when a route search for each mobility service is performed. In the present embodiment, the degree of position tolerance is indicated by a stepwise numerical value from P1 to P10. The position tolerance is larger for mobility services that are more likely to fail to meet user preferences for the departure location or arrival location. For example, the position tolerance for taxis, which are dispatched after the user specifies a departure location, is a low value of P2, whereas the position tolerance for local buses is a high value of P9. As explained below, the controller 11 may select, as a candidate service, a mobility service whose position tolerance specification is lower than the user's required specification. For example, if the user's required specification is P5, the specification for a local bus as a mobility service is P9, and the specification for a taxi is P2, the controller 11 may select the taxi, which has a specification lower than the user's required specification, as a candidate service.

The “availability of ride sharing” indicates whether ride sharing is available in the mobility service. Mobility services in which ride sharing is available allow a plurality of users to board and travel on a single vehicle.

In step S3, the controller 11 determines a required specification based on the acquired physical condition information. The controller 11 determines the degree of response speed in the required specification for each degree of physical condition from 1 to 10.

Any appropriate method may be used for the controller 11 to determine the required specification, and the same applies to steps S5, 7, and 9 below. The value of the required specification that controller 11 determines based on various information is an example and may be set freely. The same applies to steps S5, 7, and 9 below.

In the present embodiment, it is assumed that the physical condition of the user is poor, and the physical condition information indicates a value of 2. The controller 11 determines a value of R2 for the response speed. When ultimately selecting a candidate service, the controller 11 can thereby select a mobility service that can quickly acquire the route search result for a user who has a poor physical condition and presumably wishes to travel home, to a hospital, or the like.

The required specification determined based on the physical condition information is not limited to the response speed. For example, instead of, or in addition to, the above-described response speed, the controller 11 may determine the availability of ride sharing. In this case, the controller 11 may tend to determine “available ride sharing” as a required specification as the degree of the physical condition is closer to 1. For a user whose physical condition is poor and who may have an infection, the controller 11 can thereby ultimately select a mobility service that does not require riding with others.

In step S4, the controller 11 acquires schedule information that indicates a schedule for the user on a scheduled travel date and time. Any appropriate method may be used to acquire the schedule information. The controller 11 may acquire the schedule information by receiving the schedule information from the terminal apparatus 30.

In the present embodiment, the schedule information indicates one of “on duty”, “off duty”, and “on leave”. This configuration is not limiting, and the schedule information may include any information.

In step S5, the controller 11 determines a required specification based on the acquired schedule information. For example, the controller 11 determines a value of T3 for the time tolerance in a case in which the schedule information indicates that the user is on duty and determines a value of T5 in a case in which the schedule in the schedule information indicates that the user is off duty or on leave. The controller 11 can thereby select a mobility service that is as flexible in time as possible for a user on duty when ultimately selecting a candidate service. In the present embodiment, it is assumed that the schedule information indicates that the user is on leave. The controller 11 determines the time tolerance to be T5.

The required specification determined based on the schedule information is not limited to the time tolerance. For example, instead of, or in addition to, the above-described time tolerance, the controller 11 may determine the response speed. In this case, the controller 11 may determine a faster response speed when the schedule information indicates on duty than when the schedule information indicates off duty or on leave. The controller 11 can thereby ultimately select a mobility service that can quickly acquire the result of the route search for a user that is on duty.

In step S6, the controller 11 acquires weather information indicating the weather on the scheduled travel date and time. Any appropriate method may be used to acquire the weather information. The controller 11 may acquire the weather information by communicating with an external apparatus, such as a database of a weather observation center that predicts the weather for an area that includes the point of departure specified by the user, and receiving the weather information from the external apparatus.

In the present embodiment, the weather information indicates weather conditions such as “rainy”, “cloudy”, or “sunny”. This configuration is not limiting, and the weather information may include any information such as the probability of precipitation, temperature, or humidity.

In step S7, the controller 11 determines a required specification based on the acquired weather information. For example, the controller 11 determines a value of P3 for the position tolerance in a case in which the weather information indicates rain and a value of P5 in a case in which the weather information indicates cloudy or sunny. When ultimately selecting a candidate service, the controller 11 can thereby select a mobility service that is more flexible for the user in terms of the boarding or alighting location in the case of inclement weather. In the present embodiment, it is assumed that the weather information indicates rain. The controller 11 determines the position tolerance to be P3.

The required specification determined based on the weather information is not limited to the position tolerance. For example, instead of, or in addition to, the above-described position tolerance, the controller 11 may determine “outdoor transfer” as a required specification. When ultimately selecting a candidate service, the controller 11 can thereby select a mobility service that enables travel without transferring outdoors in inclement weather.

In step S8, the controller 11 acquires day of week information indicating the day of week on the scheduled travel date and time. Any appropriate method may be used to acquire the day of week information.

In the present embodiment, the day of week information indicates “weekday” and “holiday”, including Saturdays, Sundays, and holidays. This configuration is not limiting, and the day of week information may include any information related to the day of the week.

In step S9, the controller 11 determines a required specification based on the acquired day of week information. For example, the controller 11 determines to set “no ride sharing” in a case in which the day of week information indicates a weekday and determines to set “available ride sharing” in a case in which the day of week information indicates a holiday. When ultimately selecting a candidate service, the controller 11 can thereby select a mobility service with no ride sharing in a case in which it is presumed that the user may perform work during travel on a weekday. In the present embodiment, it is assumed that the day of week information indicates a weekday. The controller 11 determines to set “no ride sharing” for the availability of ride sharing.

The required specification determined based on the day of week information is not limited to the availability of ride sharing. For example, instead of, or in addition to, the above-described availability of ride sharing, the controller 11 may determine the response speed. In this case, the controller 11 may determine a faster response speed when the day of week information indicates a weekday than when the day of week information indicates a holiday. The controller 11 can thereby ultimately select a mobility service that can quickly acquire the result of the route search for a user that is presumed to be on duty on a weekday.

The above-described examples are not limiting, and any appropriate method may be used to determine the required specification based on various information. For example, the required specification may be set in advance by the user. For example, the controller 11 may determine at least one required specification based on a combination of two or more of the various types of acquired information. For example, the controller 11 may determine to set “available ride sharing” as the required specification for the availability of ride sharing in a case in which the physical condition of the user indicated by the physical condition information is 5 or higher, the schedule information indicates that the user is on leave, the weather information indicates sunny, and the day of week information indicates a holiday. The controller 11 can thereby estimate that ride sharing will take place when a user goes out on a holiday when the weather is nice and can select a mobility service that enables the user to travel with friends and the like. The controller 11 may make this estimation based on the user's past behavior history.

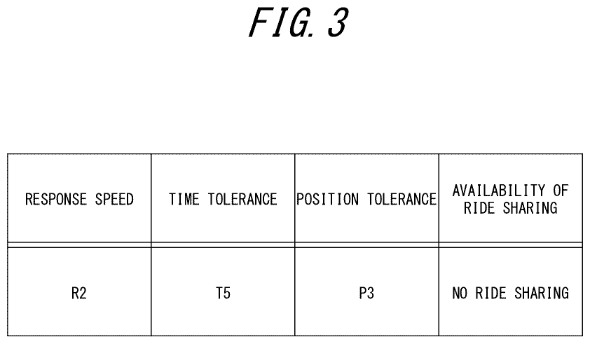

FIG. 3 is a table illustrating the user's required specifications for a mobility service as determined in steps S3, 5, 7 and 9. Referring to FIG. 3, it is determined that the response speed has a value of R2, the time tolerance has a value of T5, the position tolerance has a value of P3, and the availability of ride sharing is determined to be no ride sharing.

In step S10, the controller 11 selects at least one mobility service that meets the determined required specifications as a candidate service. Any method may be used for selection. In the present embodiment, the controller 11 selects candidate services by referring to specification information, stored in the memory 12, in which each mobility service and the corresponding specifications are registered in advance.

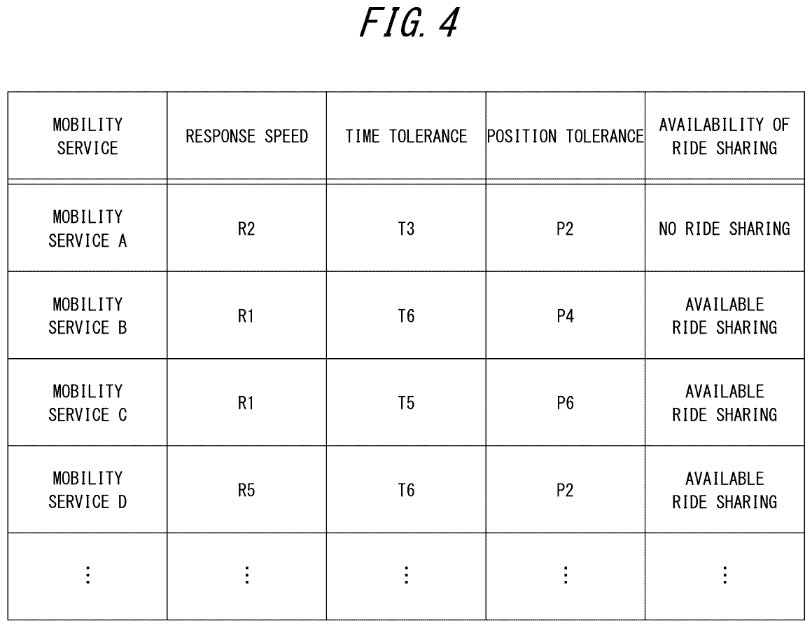

FIG. 4 illustrates an example of specification information in table format. The format of specification information is not limited to table format. The first column indicates the name of each mobility service, and the second through fifth columns represent each of the mobility service specifications: response speed, time tolerance, position tolerance, and availability of ride sharing. The controller 11 selects mobility services that meet the required specifications in FIG. 3 as candidate services. In the present embodiment, the controller 11 selects, as a candidate service, a mobility service A for which, among the specification information in FIG. 4, the response speed specification is less than or equal to than the required specification determined in step S3, the time tolerance specification is less than or equal to the required specification determined in step S5, the position tolerance specification is less than or equal to the required specification determined in step S7, and the specification for availability of ride sharing is the same as the required specification determined in step S9.

In step S11, the controller 11 makes a request to the mobility service selected in step S10 to perform a route search based on the travel request information for the user. Specifically, the controller 11 transmits a second search request via the API 200 to the server apparatus 20 of the provider of the selected mobility service. In this case, the controller 11 may be capable of converting the input values of the travel request information for the user according to the input format of the API 200. In a case of selecting a plurality of candidate services, the controller 11 may make a request for a route search to the plurality of candidate services.

For example, suppose that the input format of the API 200 provided by the server apparatus 20 for the candidate service selected in step S10 requires an input value for whether ride sharing is required, and the travel request information for the user as acquired in step S1 does not include information on whether ride sharing is required. In this case, the controller 11 may be capable of automatically determining the input value for whether ride sharing is required and transmit a search request adapted to the input format of the API 200. The input value automatically determined by the controller 11 may be set in advance, or the controller 11 may determine the input value based on the history of past user input. This ensures smooth route search requests to each server apparatus 20, even if the input format of the API 200 differs for each mobility service. The controller of the server apparatus 20 performs a route search using the routing engine based on the input values to the API 200 and transmits the result to the control apparatus 10.

In step S12, the control apparatus 10 receives the result of the route search from the server apparatus 20 and transmits the result to the terminal apparatus 30 of the user. Thereafter, the operations by the controller 11 end.

The controller 31 in the terminal apparatus 30 of the user notifies the user of the search result response received from the control apparatus 10. Any appropriate method may be used for notification. The controller 31 may further acquire information indicating whether the user accepted the candidate service after the notification and transmit this information to the control apparatus 10. In this case, based on whether the candidate service is accepted by the user, the controller 11 of the control apparatus 10 may modify the required specifications that are determined. For example, in a case in which the candidate service is accepted by the user, the required specifications that are determined with respect to the physical condition information and the like may be relaxed, whereas in a case in which the candidate service is not accepted by the user, the required specifications may be tightened. As an example of relaxing the required specifications, the controller 11 may increase the time tolerance of the required specification to T4 from T3, which is determined in the case in which the schedule information indicates that the user is on duty in step S5. As an example of tightening the required specifications, the controller 11 may decrease the time tolerance to T2 from T3, which is for the case in which the schedule information indicates that the user is on duty in step S5.

As described above, the control apparatus 10 according to the present embodiment includes a controller 11. Upon acquiring travel request information indicating a travel request of a user from a terminal apparatus 30 of the user, the controller 11 is configured to select at least one candidate service from among a plurality of mobility services based on at least one piece of information from among physical condition information on the user, schedule information on the user, weather information for a scheduled travel date and time, and day of week information for the scheduled travel date, acquire a result of a route search using the at least one candidate service, and transmit the result to the terminal apparatus 30. According to the present embodiment, the route search is performed using the most appropriate mobility service routing engine selected based on various types of information. User convenience is improved in that users do not need to request route searches separately for a plurality of mobility services with different APIs. The technology to search for routes in mobility services can thus be improved.

As described above, the controller 11 according to the present embodiment determines a required specification for the mobility service to be selected as the candidate service based on at least one of the physical condition information, the schedule information, the weather information, and the day of week information, and the required specification includes at least one of a response speed of the result of the route search using the mobility service, a time tolerance for a departure time or arrival time for preforming the route search using the mobility service, a position tolerance for a departure location or arrival location for performing the route search using the mobility service, and availability of ride sharing in the mobility service. According to the present embodiment, the controller 11 can specifically determine the required specifications for the mobility service based on various types of information and select an appropriate candidate service in accordance with the required specifications with high accuracy.

As described above, the controller 11 according to the present embodiment determines a faster degree of response speed as a required specification in a case in which the physical condition information indicates that the physical condition of the user is poor. According to the present embodiment, the controller 11 can automatically select a mobility service with a faster response speed in a case in which the user has a poor physical condition and wishes to travel quickly.

As described above, the controller 11 in the present embodiment determines no ride sharing as the required specification for the availability of ride sharing in a case in which the schedule information indicates that the user is on duty. According to the present embodiment, the controller 11 can automatically select a mobility service with no ride sharing in a case in which the user is on duty and is assumed to perform work while traveling.

### Second Embodiment

Hereinafter, a second embodiment of the present disclosure will be described. In the present embodiment, the various types of information acquired by the controller 11, such as the physical condition information, are expressed as binary values. Specifically, the physical condition information indicates that the physical condition of the user is “good” or “poor”, the weather information indicates that the weather on the scheduled travel date and time is “good” or “poor”, the day of week information indicates that the scheduled travel date and time is a “weekday” or “holiday”, and the schedule information indicates that the user's schedule on the scheduled travel date and time is “on duty” or “off duty”. The memory 12 of the control apparatus 10 stores correspondence information, in which the mobility service corresponding to all 16 combinations of these pieces of information is registered in advance. The controller 11 acquires the correspondence information by reading it from the memory 12 and refers to the correspondence information to select a candidate service. The various types of information are not limited to being expressed by binary values, as described above, and may be expressed by any discrete values.

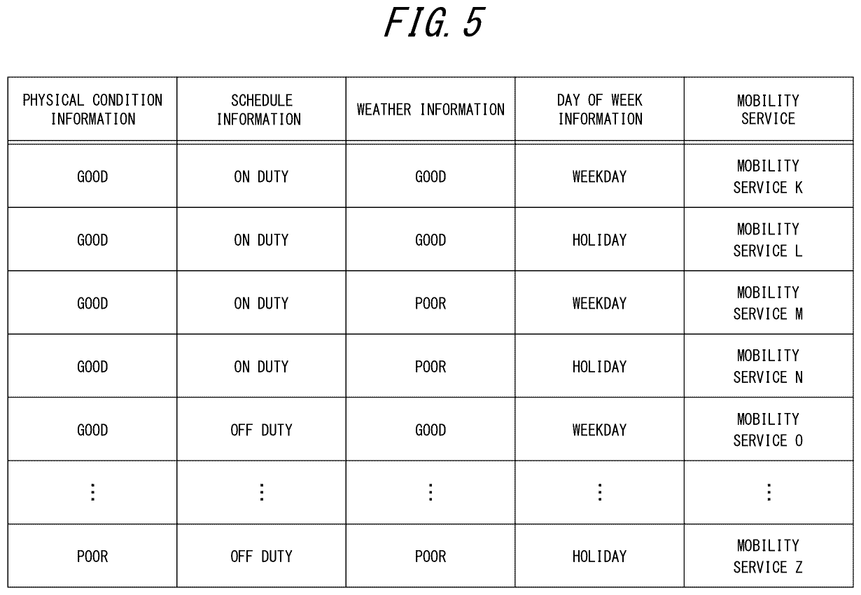

FIG. 5 illustrates an example of correspondence information according to the present embodiment. Referring to FIG. 5, mobility service K is associated with a case in which the physical condition information indicates “good”, the schedule information indicates “on duty”, the weather information indicates “good”, and the day of week information indicates “weekday”. The controller 11 refers to the correspondence information and selects, as a candidate service, the mobility service that corresponds to the acquired various types of information. The controller 11 then makes a request for a route search via the API 200 to the server apparatus 20 of the selected candidate service, as in the first embodiment, and transmits the result of the route search returned by the server apparatus 20 to the terminal apparatus 30 of the user.

As described above, the controller 11 according to the present embodiment acquires correspondence information associating the physical condition information, the schedule information, the weather information, and the day of week information with the mobility service and selects the candidate service based on the correspondence information. According to the present embodiment, the controller 11 can efficiently select the candidate service, since the mobility service corresponding to the various types of information is already determined. The technology to search for routes in mobility services can thus be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

1. A control apparatus comprising a controller, wherein the controller is configured to, upon acquiring travel request information indicating a travel request of a user from a terminal apparatus of the user, select at least one candidate service from among a plurality of mobility services based on at least one piece of information from among physical condition information on the user, schedule information on the user, weather information for a scheduled travel date and time, and day of week information for the scheduled travel date, acquire a result of a route search using the at least one candidate service, and transmit the result to the terminal apparatus.

2. The control apparatus according to claim 1, wherein
the controller is configured to determine a required specification for the mobility service to be selected as the candidate service based on at least one of the physical condition information, the schedule information, the weather information, and the day of week information, and
the required specification includes at least one of a response speed of the result of the route search using the mobility service, a time tolerance for a departure time or arrival time for preforming the route search using the mobility service, a position tolerance for a departure location or arrival location for performing the route search using the mobility service, and availability of ride sharing in the mobility service.

3. The control apparatus according to claim 2, wherein the controller is configured to determine a faster degree of response speed as the required specification in a case in which the physical condition information indicates that a physical condition of the user is poor.

4. The control apparatus according to claim 2, wherein the controller is configured to determine no ride sharing as the required specification for the availability of ride sharing in a case in which the schedule information indicates that the user is on duty.

5. The control apparatus according to claim 2, wherein the controller is configured to acquire correspondence information associating the physical condition information, the schedule information, the weather information, and the day of week information with the mobility service and select the candidate service based on the correspondence information.
